(19) United States
(12) Patent Application Publication
(10) Pub. No.: US 2012/0159540 A1
(43) Pub. Date: Jun. 21, 2012

(54) SYSTEM AND METHOD FOR PROVIDING PERSONALIZED CONTENT

(75) Inventors: Min-Sik PARK, Daejeon (KR); Chung Hyun AHN, Daejeon (KR); Jin Woo HONG, Daejeon (KR)

(73) Assignee: Electronics and Telecommunications Research Institute, Daejeon (KR)

(21) Appl. No.: 13/328,934

(22) Filed: Dec. 16, 2011

(30) Foreign Application Priority Data
Dec. 16, 2010 (KR) 10-2010-0129403
Mar. 11, 2011 (KR) 10-2011-0021957

(51) Int. Cl. H04N 21/258

(52) U.S. Cl. 725/34

(57) ABSTRACT

A personalized content server selects content that is personalized for a user based on watching information and mobile terminal information about the user from among pieces of content associated with broadcasting content being watched by the user through a broadcasting terminal, and transmits the selected personalized content to the mobile terminal of the user through the broadcasting terminal.

### CROSS-REFERENCE TO RELATED APPLICATION

This application claims priority to and the benefit of Korean Patent Application No. 10-2010-0129403 and 10-2011-0021957 filed in the Korean Intellectual Property Office on Dec. 16, 2010 and Mar. 11, 2011, the entire contents of which are incorporated herein by reference.

### BACKGROUND OF THE INVENTION

(a) Field of the Invention

The present invention relates to a system and method for providing personalized content, which provide personalized content for a user through a mobile terminal of the user in association with broadcasting content.

(b) Description of the Related Art

Supplementary content currently being provided through broadcasting media is multiplexed with broadcasting content and transmitted in the form of a broadcasting signal. A broadcasting terminal receives the broadcasting signal and displays the supplementary content on a TV screen along with the broadcasting content.

In order to display both the supplementary content and the broadcasting content on the TV screen, a method of resizing the display screen of the broadcasting content to an original size is chiefly used. If several persons are watching the broadcasting content and a specific user changes the configuration of the TV screen in order to consume supplementary content, the remaining users may have difficulty in properly watching the broadcasting content. In other words, a broadcasting service where supplementary content together with broadcasting content is consumed is effective when a person watches the broadcasting service by himself, but may not be suitable when several users exist. Furthermore, as more and more personalized content is consumed, there is a need for a method of providing a user with personalized content even in a broadcasting environment.

Furthermore, an advertisement currently being provided through a broadcasting medium is inserted between broadcasting programs, and sponsors chiefly provide advertisements related to the contents of broadcasting content. However, there is a limit to the providing of an advertisement that may have interest for all users who watch the relevant broadcasting content because the users have different characteristics and propensities. This situation may become one of reasons that an advertisement through a broadcasting medium does not have a great effect with respect to cost.

In order to ameliorate this drawback, research is being carried out on targeting advertisement technology for providing an advertisement including contents having interest for a user by checking personal information or content preference of the user through bi-directional broadcasting through a communication channel. However, from a viewpoint of personal information protection, it is difficult to easily gather pieces of personal information. If several users watch a TV, it is difficult to determine which advertisement should be provided on the basis of what user. Consequently, an effective targeting advertisement through broadcasting media is not provided.

### SUMMARY OF THE INVENTION

The present invention has been made in an effort to provide a system and method for providing personalized content, having an advantage of providing content personalized for a user propensity without affecting the screen of broadcasting content watched by other users if several users watch broadcasting content.

An exemplary embodiment of the present invention provides a system for providing personalized content to a user who watches broadcasting content in association with the broadcasting content. The system for providing personalized content includes a content re-processing unit and a content transmitting/receiving unit. The content re-processing unit searches for contents associated with broadcasting content currently being watched by the user, based on watching information about the user and for selecting the personalized content correspoding to mobile terminal information of the user, from among the contents. Furthermore, the content transmitting/receiving unit receives the watching information and the mobile terminal information of the user, transfers the watching information and the mobile terminal information to the content re-processing unit, and transmits the personalized content to the mobile terminal.

According to another exemplary embodiment of the present invention, a method of a broadcasting terminal providing broadcasting content received from a broadcasting server and providing personalized content is provided. The method of providing personalized content includes the steps of providing the broadcasting content received from the broadcasting server to a screen, receiving mobile terminal information from a mobile terminal of a user who watches the broadcasting content, obtaining watching information of the user, transmitting the mobile terminal information and the watching information to a personalized content server, and receiving the personalized content correspoding to the watching information and the mobile terminal information of the user from the personalized content server, and transmitting the received personalized content to the mobile terminal.

According to yet another exemplary embodiment of the present invention, a method of providing personalized content to a mobile terminal of a user watching broadcasting content received from a broadcasting server is provided. The method of providing personalized content includes the steps of receiving the broadcasting content from the broadcasting server and transmitting the received broadcasting content to a broadcasting terminal, and receiving personalized content correspoding to watching information and the mobile terminal information of the user, from among pieces of content associated with the broadcasting content, from a personalized content server via the broadcasting terminal and providing the received personalized content to the user.

According to a further exemplary embodiment of the present invention, a method of a personalized content server providing personalized content to a user who watches broadcasting content in association with the broadcasting content is provided. The method of providing personalized content includes the steps of receiving watching information about the user and mobile terminal information about a mobile terminal of the user from a broadcasting terminal for providing the broadcasting content to the user through a screen, searching for supplementary contents related to the broadcasting content currently being watched by the user based on the watching information of the user, and selecting supplementary content correspoding to terminal unique specification information of the mobile terminal information from among the supplementary contents and transmitting the selected supplementary content to the mobile terminal through the broadcasting terminal.

### BRIEF DESCRIPTION OF THE DRAWINGS

FIG. 1 is a diagram showing a system for providing personalized content according to an exemplary embodiment of the present invention;

FIG. 2 is a diagram showing a personalized content server shown in FIG. 1;

FIG. 3 is a diagram showing a broadcasting terminal shown in FIG. 1;

FIG. 4 is a diagram showing a mobile terminal shown in FIG. 1;

FIG. 5 is a diagram showing a method of providing personalized content in the system for providing personalized content according to an exemplary embodiment of the present invention; and

FIG. 6 is a flowchart illustrating a method of the personalized content server providing personalized content according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A system and method for providing personalized content according to some exemplary embodiments of the present invention are described in detail below with reference to the accompanying drawings.

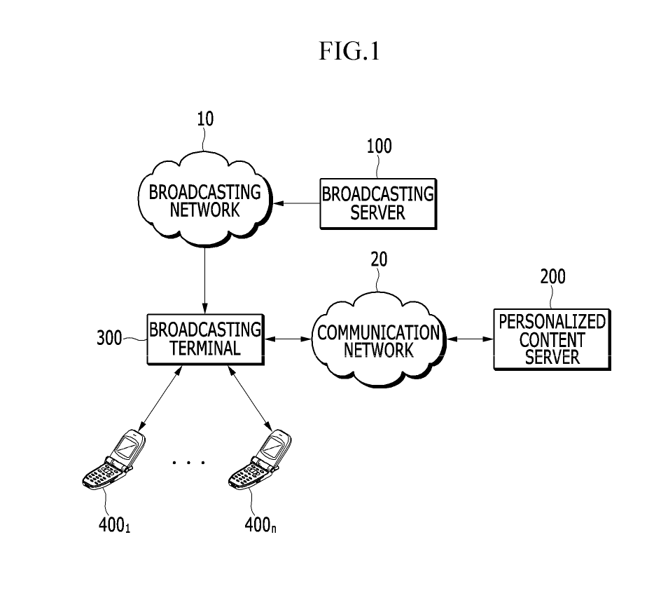

FIG. 1 is a diagram showing a system for providing personalized content according to an exemplary embodiment of the present invention.

Referring to FIG. 1, the system for providing personalized content includes a broadcasting server 100, a personalized content server 200, a broadcasting terminal 300, and one or more mobile terminals 400₁ to 400ₙ

The broadcasting server 100 transmits a broadcasting signal over a broadcasting network 10. That is, the broadcasting server 100 functions to transmit broadcasting content in the form of a digital broadcasting signal. The broadcasting server 100 may exist in a broadcasting station.

The broadcasting network 10 may be a terrestrial wave network, a satellite network, a cable network, an Internet protocol television (IPTV) network, etc. The digital broadcasting signal may be transmitted over a terrestrial network, a satellite network, a cable network, an Internet protocol television (IPTV) network, etc.

The broadcasting server 100 receives broadcasting content from a content provider, stores the received broadcasting content, generates a broadcasting signal by encoding and modulating the broadcasting content, and transmits the broadcasting signal over the broadcasting network 10. Accordingly, the broadcasting server 100 may be considered to be a digital broadcasting transmission system that may be installed so that a broadcasting station provides digital broadcasting.

The broadcasting terminal 300 may receive a broadcasting signal transmitted by the broadcasting server 100 over the broadcasting network 10, display the broadcasting content on a TV screen, connect with the mobile terminal 400 that is portable by a user through a communication channel, and transmit and receive data and content to and from the mobile terminal 400.

Furthermore, the broadcasting terminal 300 is connected with the personalized content server 200 over a communication network 20. The broadcasting terminal 300 receives content that is personalized for a user from the personalized content server 200 and provides the personalized content to the mobile terminals 400₁ to 400ₙ that are portable by relevant users.

The broadcasting terminal 300 may be built into a TV or may be implemented separately from the TV in a set-top box form.

The one or more mobile terminals 400₁ to 400ₙ are portable multimedia terminals having a bi-directional communication function for transmitting and receiving data and content to and from the broadcasting terminal 300. The mobile terminals 400₁ to 400ₙ may include mobile phones, personal multimedia players (PMPs), laptops, netbooks, e-books, game players, etc.

The mobile terminals 400₁ to 400ₙ may independently communicate with the broadcasting terminal 300, and they may be synchronized with the one broadcasting terminal 300. For example, when a married couple watches broadcasting content through one broadcasting terminal 300, a mobile terminal owned by the husband may be synchronized with the broadcasting terminal 300 and, at the same time, a mobile terminal owned by the wife may be synchronized with the broadcasting terminal 300.

The personalized content server 200 selects pieces of personalized content that are suitable for the respective consumption environments of the mobile terminals 400₁ to 400ₙ and for the respective user characteristics of the mobile terminals 400₁ to 400ₙ, at the requests of the pieces of content from the mobile terminals 400₁ to 400ₙ through the broadcasting terminal 300, and provides the pieces of personalized content to the respective mobile terminals 400₁ to 400ₙ. The personalized content may be at least one of supplementary content and advertisement content that are associated with broadcasting content that is currently being watched by a user.

In other words, the personalized content server 200 may provide the mobile terminals 400₁ to 400ₙ with supplementary content having the same contents in different forms according to the consumption environments of the mobile terminals 400₁ to 400ₙ and the user characteristics of the mobile terminals 400₁ to 400ₙ.

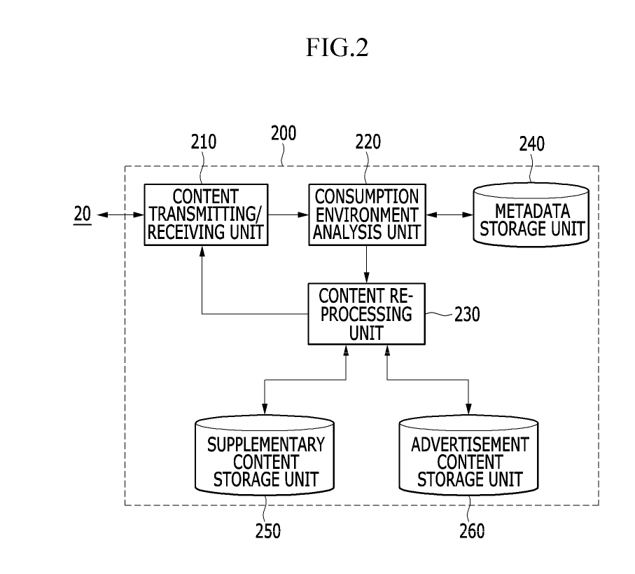

FIG. 2 is a diagram showing the personalized content server shown in FIG. 1.

The personalized content server 200 is described with reference to FIG. 2, assuming that personalized content is provided to the user of one mobile terminal 400₁ from among the one or more mobile terminals 400₁-400ₙ that are connected with the one broadcasting server 300 for communication, for convenience of description.

Referring to FIG. 2, the personalized content server 200 includes a content transmitting/receiving unit 210, a consumption environment analysis unit 220, a content re-processing unit 230, a metadata storage unit 240, a supplementary content storage unit 250, and an advertisement content storage unit 260.

The content transmitting/receiving unit 210 receives watching information, mobile terminal information, and content request information about a user from the broadcasting terminal 300 over the communication network 20, and transfers them to the consumption environment analysis unit 220. The content transmitting/receiving unit 210 also transmits personalized content, received from the content re-processing unit 230, to the mobile terminal 400₁ through the communication network 20 and the broadcasting terminal 300.

The watching information may include a channel currently being watched by the user and a channel identifier and a broadcasting content identifier indicative of broadcasting content. That is, the channel identifier and the content identifier are pieces of information identified by the personalized content server 200 regarding what broadcasting content is currently being watched by a user on what channel. The channel identifier may be the number of a channel currently being watched by a user. Furthermore, the broadcasting content identifier may be a unique identifier allocated to each piece of broadcasting content so that the broadcasting content can be identified.

The mobile terminal information may include unique specification information and user information about the mobile terminal 400₁ which is currently used for a user to watch a channel. The unique specification information may include the screen size of the mobile terminal 400₁, the content type supported by the mobile terminal 400₁, etc. The user information may include pieces of information about the age, gender, occupation, current location, etc. of a user who uses the mobile terminal 400₁. The content type may include a Wireless Application Protocol (WAP), XML, HTML, Java script, and so on.

The mobile terminal information may include information necessary for the personalized content server 200 to provide personalized content (i.e., personalized supplementary content and personalized advertisement content) that is personalized for the user of the mobile terminal 400₁.

The content request information is transmitted from the mobile terminal 400₁ to the personalized content server 200 through the broadcasting terminal 300. The content request information may include a supplementary content identifier that enables the personalized content server 200 to identify supplementary content requested by the mobile terminal 400₁.

The user watching information, the mobile terminal information, and the content request information may be encoded in various data formats (e.g., text, hypertext markup language (HTML), and extensible markup language (XML)) and may be transmitted from the broadcasting terminal 300 to the personalized content server 200 according to various transmission schemes (e.g., hypertext transfer protocol (HTTP) and file transfer protocol (FTP)).

The consumption environment analysis unit 220 converts the user watching information, the mobile terminal information, and the content request information that is received from the content transmitting/receiving unit 210 in the form of a message that may be identified by the personalized content server 200. Next, the consumption environment analysis unit 220 identifies broadcasting content or a broadcasting content section or both that are currently being watched by the user with reference to broadcasting content information, stored in the metadata storage unit 240, based on the user watching information.

Furthermore, the consumption environment analysis unit 220 transfers a user watching content identifier indicating the broadcasting content or the broadcasting content section or both that are currently being watched by the user to the content re-processing unit 230 along with the mobile terminal information and the content request information.

The content re-processing unit 230 searches the supplementary content storage unit 250 for supplementary content related to the broadcasting content currently being watched by the user, based on the content request information and the user watching content identifier received from the consumption environment analysis unit 220, and selects personalized supplementary content that is suitable for the consumption environment of the mobile terminal 400₁ from among pieces of the retrieved supplementary content, through the mobile terminal information. That is, the content request information includes the identifier of supplementary content selected by a user in the mobile terminal 400₁ so that the supplementary content related to broadcasting content currently being watched by the user can be identified by the personalized content server 200 when the supplementary content is required from the personalized content server 200. Furthermore, the user watching content identifier is information identified by the personalized content server 200 regarding what broadcasting content is currently being watched by a user. Accordingly, the content re-processing unit 230 may search the supplementary content storage unit 250 for the supplementary content that will be provided to the user based on the user watching content identifier and the content request information.

The content re-processing unit 230 transfers the selected supplementary content to the content transmitting/receiving unit 210 so that the selected supplementary content is transmitted to the mobile terminal 400₁ through the broadcasting server 300.

Furthermore, the content re-processing unit 230 determines whether to transmit the selected supplementary content together with advertisement content. If the selected supplementary content, together with the advertisement content, is to be transmitted, the content re-processing unit 230 searches the advertisement content storage unit 260 for the advertisement content related to the broadcasting content currently being watched by the user based on the user watching content identifier received from the consumption environment analysis unit 220, and selects personalized advertisement content suitable for the user of the mobile terminal 400₁ from among pieces of the retrieved advertisement content based on the mobile terminal information. Next, the content re-processing unit 230 transfers the selected personalized advertisement content to the content transmitting/receiving unit 210 so that the selected personalized advertisement content is transmitted to the mobile terminal 400₁ through the broadcasting server 300.

If the personalized supplementary content, together with the personalized advertisement content, is to be transmitted, the content re-processing unit 230 may generate a piece of personalized content by combining the personalized supplementary content and the personalized advertisement content and transfer the personalized content to the content transmitting/receiving unit 210.

The metadata storage unit 240 stores broadcasting content information about the broadcasting content transmitted by the broadcasting server 100. The consumption environment analysis unit 220 identifies the broadcasting content or the broadcasting content section or both that are currently being watched by the user by searching the metadata storage unit 240. The broadcasting content information may include program information, channel information, titles, summary information, and section information about all pieces of broadcasting content that are transmitted by the broadcasting server 100. Accordingly, broadcasting content and a broadcasting content section currently being watched by a user at a relevant time can be identified based on the channel information and the watching time information.

The supplementary content storage unit 250 stores pieces of supplementary content that are previously produced in relation to broadcasting content. Here, the pieces of supplementary content have the same contents, but may be produced in various forms according to a screen size, a supported content type, etc. of a mobile terminal and stored in the supplementary content storage unit 250.

The advertisement content storage unit 260 stores pieces of advertisement content that are previously produced in relation to broadcasting content. Here, the advertisement content of various forms that is produced according to the user characteristics of a mobile terminal may be stored in the advertisement content storage unit 260. For example, if advertisement content for clothes worn by a hero is transmitted from the personalized content server 200 to the mobile terminal 400₁ when a user watches a drama through the broadcasting terminal 300, the content re-processing unit 230 may search the advertisement content storage unit 260 for advertisement content for clothes worn by a male hero if the user of the mobile terminal 400₁ is a male and provide the retrieved advertisement content to the user. If the user of the mobile terminal 400₁ is a female, however, the content re-processing unit 230 may search the advertisement content storage unit 260 for advertisement content for clothes worn by a female hero and provide the retrieved advertisement content to the user.

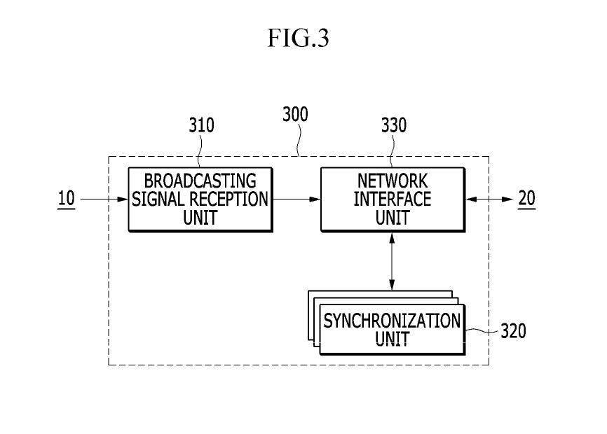

FIG. 3 is a diagram showing the broadcasting terminal shown in FIG. 1.

Referring to FIG. 3, the broadcasting terminal 300 includes a broadcasting signal reception unit 310, a synchronization unit 320, and a network interface unit 330.

The broadcasting signal reception unit 310 receives a digital broadcasting signal over the broadcasting network 10, plays broadcasting content on the TV screen of a user, and transfers current watching information about the user to the network interface unit 330.

The synchronization unit 320 performs section setting with the mobile terminals 400₁ to 400ₙ through respective communication channels, receives pieces of mobile terminal information and pieces of content request information from the respective mobile terminals 400₁ to 400ₙ, and transmit pieces of personalized content to the respective mobile terminals 400₁ to 400ₙ. The communication channel may include wired/wireless communication means, such as a local area network (LAN), a wireless local area network (WLAN), wideband code division multiple access (WCDMA), wideband wireless communication such as Wi-Fi, visible ray communication, infrared communication, Zigbee, and Bluetooth. A transfer protocol for the communication channel may include standards such as Digital Living Network Alliance (DLNA), Universal Plug & Play (UPnP), MPEG-U, and MPEG-V, or non-standards defined by companies.

The network interface unit 330 receives watching information about a user from the broadcasting signal reception unit 310, receives mobile terminal information from the synchronization unit 320, and transmits the watching information and the mobile terminal information to the personalized content server 200. Furthermore, the network interface unit 330 receives personalized content from the personalized content server 200 and transmits the personalized content to the synchronization unit 320.

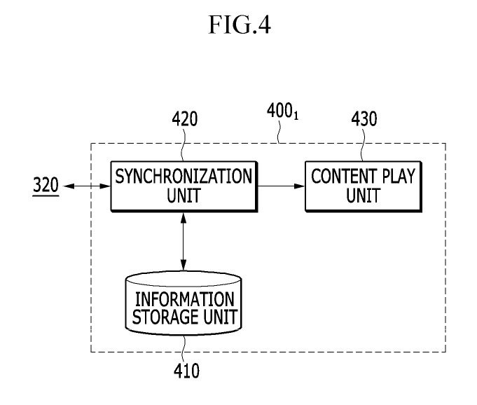

FIG. 4 is a diagram showing the mobile terminal shown in FIG. 1.

Although only one mobile terminal 400₁ is shown in FIG. 4, the remaining mobile terminals 400₂ to 400ₙ may have the same construction as the mobile terminal 400₁.

Referring to FIG. 4, the mobile terminal 400₁ includes an information storage unit 410, a synchronization unit 420, and a content play unit 430.

The information storage unit 410 obtains, stores, and manages mobile terminal information about the mobile terminal 400₁ and transfers the mobile terminal information to the synchronization unit 420. The mobile terminal information may include unique specification information about the mobile terminal 400₁ such as the screen size, supported content type, etc. of the mobile terminal 400₁, user information such as the age, gender, occupation, current location of a user, and so on.

The synchronization unit 420 performs section setting with the broadcasting terminal 300 through a communication channel, transfers the mobile terminal information to the broadcasting terminal 300, receives personalized content corresponding to content request information from the broadcasting terminal 300, and transfers the received personalized content to the content play unit 430. Furthermore, the synchronization unit 420 receives content request information that is requested by a user from the content play unit 430, and transmits the received content request information to the broadcasting terminal 300.

The content play unit 430 provides the personalized content that is received from the synchronization unit 420 on a screen of the mobile terminal 400₁, and transfers the content request information that is requested by the user through user interaction to the synchronization unit 420.

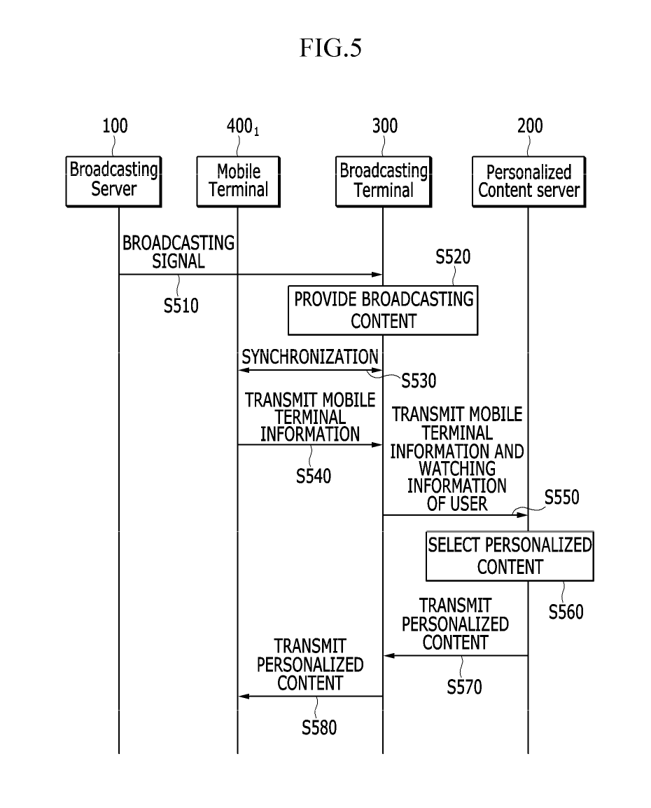

FIG. 5 is a diagram showing a method of providing personalized content in the system for providing personalized content according to an exemplary embodiment of the present invention.

Referring to FIG. 5, the broadcasting server 100 generates a broadcasting signal by encoding and modulating produced broadcasting content and transmits the broadcasting signal to the broadcasting terminal 300 over the broadcasting network 10 at step S510.

The broadcasting terminal 300 receives the broadcasting signal from the broadcasting server 100, and provides broadcasting content obtained by demodulating and decoding the received broadcasting signal to the TV screen of a user at step S520.

At this time, the broadcasting terminal 300 receives a content request from the user who is watching the broadcasting content from the mobile terminal 400₁, and sets a communication channel and synchronization between the mobile terminal 400₁ and the broadcasting terminal 300 in response to the request at step S530.

After the communication channel and synchronization has been set, the mobile terminal 400₁ transfers its mobile terminal information to the broadcasting terminal 300 at step S540.

The broadcasting terminal 300 obtains watching information about the user by itself and transmits the obtained watching information and the mobile terminal information received from the mobile terminal 400₁ to the personalized content server 200 at step S550.

The personalized content server 200 selects personalized content associated with the broadcasting content currently being watched and matched with the unique specification of the mobile terminal 400₁ and the user information of the mobile terminal 400₁, based on the mobile terminal information and the watching information at step S560, and transmits the selected personalized content to the mobile terminal 400₁ via the broadcasting terminal 300 at steps S570 and S580. Here, the personalized content may be supplementary content or may be a piece of content in which the supplementary content and advertisement content are combined.

The mobile terminal 400₁ provides the received personalized content to a screen through the broadcasting terminal 300.

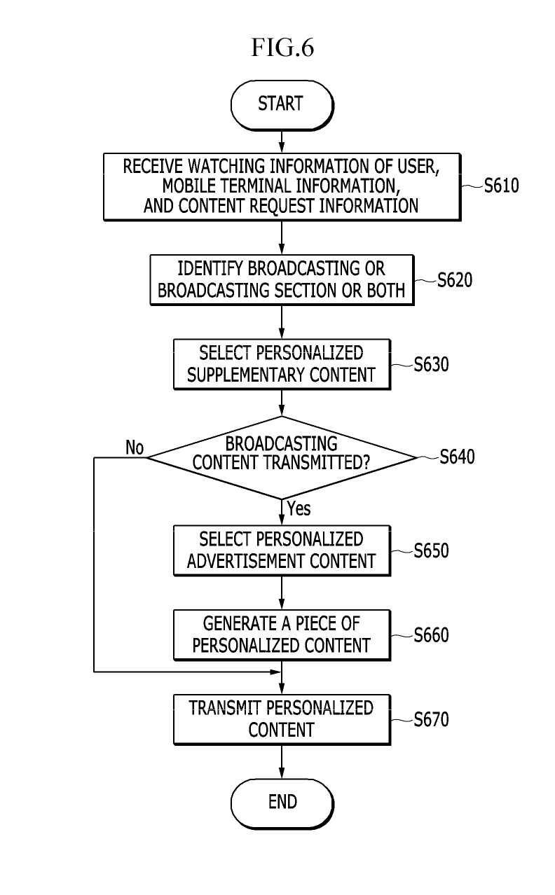

FIG. 6 is a flowchart illustrating a method of the personalized content server providing personalized content according to an exemplary embodiment of the present invention.

Referring to FIG. 6, the content transmitting/receiving unit 210 of the personalized content server 200 receives watching information, mobile terminal information, and content request information about a user from the broadcasting terminal 300 at step S610.

The consumption environment analysis unit 220 of the personalized content server 200 receives the watching information, the mobile terminal information, and the content request information of the user from the content transmitting/receiving unit 210, and identifies broadcasting content or a broadcasting content section or both that are currently being watched by searching the metadata storage unit 240 based on the watching information of the user at step S620. The consumption environment analysis unit 220 transfers a user watching content identifier corresponding to the identified broadcasting content or the identified broadcasting content section or both, together with the mobile terminal information, to the content re-processing unit 230.

The content re-processing unit 230 of the personalized content server 200 receives the user watching content identifier, the mobile terminal information, and the content request information from the consumption environment analysis unit 220, searches the advertisement content storage unit 260 for supplementary content related to the broadcasting content based on the user watching content identifier and the content request information, and selects personalized supplementary content suitable for being played in the mobile terminal 400₁ based on the mobile terminal information from among pieces of the retrieved supplementary content at step S630.

Next, the content re-processing unit 230 determines whether to transmit both the selected personalized supplementary content and personalized advertisement content at step S640.

If, as a result of the determination, both the selected supplementary content and the personalized advertisement content are determined to be transmitted, the content re-processing unit 230 searches the advertisement content storage unit 260 for advertisement content associated with the broadcasting content based on the user watching content identifier, and selects personalized advertisement content suitable for the user characteristics of the mobile terminal 400₁ from among pieces of the retrieved advertisement content at step S650.

The content re-processing unit 230 generates a piece of personalized content by combining the personalized supplementary content and the personalized advertisement content at step S660, and transmits the personalized content to the broadcasting terminal 300 at step S670.

If, as a result of the determination, both the selected supplementary content and the personalized advertisement content are determined to not be transmitted, the content re-processing unit 230 transmits only the personalized supplementary content to the broadcasting terminal 300 at step S670.

According to an exemplary embodiment of the present invention, supplementary content that is personalized for a user propensity can be provided through a mobile terminal that is portable by a user in association with broadcasting content currently being watched. Accordingly, a user can consume personalized content without changing the TV screen of other users who watch the broadcasting content.

Furthermore, according to an exemplary embodiment of the present invention, not only is supplementary content personalized for a user, but also advertisement content that is personalized for the user can be provided through a mobile terminal in association with a broadcasting program currently being watched. Accordingly, an advertisement effect can be improved from a viewpoint of a sponsor.

In addition, according to an exemplary embodiment of the present invention, there are advantages in that a variety of business models can be created in association with the consumption of broadcasting content and thus profits can be increased from a viewpoint of a service provider or a manufacturer.

The exemplary embodiments of the present invention are not implemented only through the method or the apparatus or both, but may be implemented through a program for realizing a function corresponding to a construction according to the exemplary embodiment of the present invention or a recording medium on which the program is recorded. The implementations will be evident to those having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing personalized content to a user who watches broadcasting content in association with the broadcasting content, the system comprising:
a content re-processing unit for searching for contents associated with broadcasting content currently being watched by the user, based on watching information about the user and for selecting the personalized content correspoding to mobile terminal information of the user, from among the contents; and
a content transmitting/receiving unit for receiving the watching information and the mobile terminal information of the user, transferring the watching information and the mobile terminal information to the content re-processing unit, and transmitting the personalized content to the mobile terminal.

2. The system of claim 1, wherein the personalized content comprises supplementary content.

3. The system of claim 1, wherein the personalized content comprises supplementary content and advertisement content.

4. The system of claim 3, wherein
the mobile terminal information comprises unique specification information about the mobile terminal and user information, and
the content re-processing unit selects supplementary content correspoding to the unique specification information about the mobile terminal from among pieces of the supplementary content associated with the broadcasting content currently being watched by the user, and selects advertisement content correspoding to the user information from among pieces of the advertisement content associated with the broadcasting content currently being watched by the user.

5. The system of claim 4, further comprising:
a supplementary content storage unit for storing pieces of the supplementary content having identical contents according to the unique specification information of the mobile terminal; and
an advertisement content storage unit for storing pieces of the advertisement content according to characteristics of a user of the mobile terminal.

6. The system of claim 4, further comprising:
a metadata storage unit for storing broadcasting content information related to the broadcasting content provided by a broadcasting server; and
a consumption environment analysis unit for identifying a broadcasting content section, currently being watched by the user, in the metadata storage unit based on watching information of the user and for transferring the identified broadcasting content section to the content re-processing unit.

7. The system of claim 4, wherein the content re-processing unit generates the personalized content by combining the selected supplementary content and the selected advertisement content.

8. The system of claim 1, wherein the content transmitting/receiving unit receives the watching information and the mobile terminal information of the user through a broadcasting terminal connected thereto over a communication network.

9. A method of a broadcasting terminal providing broadcasting content received from a broadcasting server, and providing personalized content, the method comprising the steps of:
providing the broadcasting content received from the broadcasting server to a screen;
receiving mobile terminal information from a mobile terminal of a user who watches the broadcasting content;
obtaining watching information of the user;
transmitting the mobile terminal information and the watching information to a personalized content server; and
receiving the personalized content correspoding to the watching information and the mobile terminal information of the user from the personalized content server, and transmitting the received personalized content to the mobile terminal.

10. The method of claim 9, wherein the watching information comprises a channel identifier and a broadcasting content identifier of a channel and the broadcasting content that are currently being watched by the user,
the mobile terminal information comprises unique specification information and user information about the mobile terminal, and
the user information comprises at least one of age, gender, occupation, and a current location.

11. The method of claim 9, wherein the step of receiving the mobile terminal information comprises the step of receiving a content request from the mobile terminal and setting a communication channel and synchronization with the mobile terminal.

12. The method of claim 9, wherein the personalized content comprises at least one of supplementary content and advertisement content that are associated with the broadcasting content.

13. A method of providing personalized content to a mobile terminal of a user watching broadcasting content received from a broadcasting server, the method comprising the steps of:
receiving the broadcasting content from the broadcasting server and transmitting the received broadcasting content to a broadcasting terminal; and
receiving personalized content correspoding to watching information and the mobile terminal information of the user from among pieces of content associated with the broadcasting content from a personalized content server via the broadcasting terminal, and providing the received personalized content to the user.

14. The method of claim 13, wherein the watching information comprises a channel identifier and a broadcasting content identifier of a channel and the broadcasting content that are currently being watched by the user,
the mobile terminal information comprises unique specification information and user information about the mobile terminal, and
the user information comprises at least one of age, gender, occupation, and current location.

15. The method of claim 13, wherein the step of transmitting the mobile terminal information to the broadcasting terminal comprises the step of setting a communication channel and synchronization with the broadcasting terminal.

16. The method of claim 13, wherein the personalized content comprises at least one of supplementary content and advertisement content.

17. A method of a personalized content server providing personalized content to a user who watches broadcasting content in association with the broadcasting content, the method comprising the steps of:
receiving watching information about the user and mobile terminal information about a mobile terminal of the user from a broadcasting terminal for providing the broadcasting content to the user through a screen;
searching for supplementary contents related to the broadcasting content currently being watched by the user based on the watching information of the user; and
selecting supplementary content correspoding to terminal specification information of the mobile terminal information from among the supplementary contents and transmitting the selected supplementary content to the mobile terminal through the broadcasting terminal.

18. The method of claim 17, further comprising the steps of:
searching for advertisement content related to the broadcasting content currently being watched by the user based on the watching information of the user; and
selecting advertisement content correspoding to user information of the mobile terminal information from among pieces of the retrieved advertisement content and transmitting the selected advertisement content to the mobile terminal through the broadcasting terminal.

19. The method of claim 18, wherein the step of selecting the advertisement content and transmitting the selected advertisement content to the mobile terminal comprises the step of generating a piece of content by combining the selected supplementary content and the selected advertisement content.

20. The method of claim 17, wherein the watching information comprises identifiers of a channel and the broadcasting content that are currently being watched by the user, and
the method further comprises the step of identifying the broadcasting content currently being watched by the user based on the watching information of the user before the step of searching for the supplementary content related to the broadcasting content.
